(19) United States
(12) Patent Application Publication
(10) Pub. No.: US 2002/0148276 A1
(43) Pub. Date: Oct. 17, 2002

(54) Method and arrangement for calibrating an unbalance measuring apparatus

(75) Inventor: Eickhart Goebel, Pfungstadt (DE)

Correspondence Address: OSTROLENK FABER GERB & SOFFEN, 1180 AVENUE OF THE AMERICAS, NEW YORK, NY, 100368403

(73) Assignee: Snap-On Deutschland Holding GmbH

(21) Appl. No.: 10/053,774

(22) Filed: Jan. 22, 2002

(30) Foreign Application Priority Data
Feb. 9, 2001 (DE) 101 05 939.6

(51) Int. Cl. G01L 25/00

(52) U.S. Cl. 73/1.14

(57) ABSTRACT

A method and an apparatus for calibrating an unbalance measuring apparatus, in which in a calibration run two calibration masses of the same or different sizes are simultaneously caused to rotate about a measuring axis in two axial calibration planes, wherein a calibration mass rotating about the measuring axis is simulated in another axial plane.

### FIELD OF THE INVENTION

The invention concerns a method and an arrangement for calibrating an unbalance measuring apparatus.

### BACKGROUND OF THE INVENTION

In one form of method of calibrating an unbalance measuring apparatus, given calibration masses are caused to rotate about a measuring axis in given axial and radial positions, in calibration runs, and in that procedure the forces which result from unbalances caused by the calibration masses are measured. The measured forces are then evaluated for calibration of the unbalance measuring apparatus. In regard to further details of such a method, and an arrangement for carrying out the method, reference may be made to EP 0 133 229 B1. In that method and the corresponding apparatus, for the purposes of calibrating the unbalance measuring apparatus, a first calibration mass of a known size is firstly arranged in a first calibration plane which extends in a given axial position perpendicularly relative to the measuring axis, and at a given radial spacing from the first measuring axis. That first calibration mass is then caused to rotate about the measuring axis. In addition, a second calibration mass of known size is rotated about the measuring axis at a given radial spacing, in a second calibration plane at an axial position which is different in relation to the first calibration plane. During the two calibration runs, the operating procedure of that method involves measuring the forces resulting from the unbalances produced by the calibration masses, with subsequent evaluation for calibration of the balancing machine. A comparison is made between the calculated unbalance and the unbalance arising out of the respective calibration masses, and that comparison is used as a basis for calculating correction factors for calibration of the balancing machine.

The arrangement of the calibration mass in each respective calibration plane is linked to the arrangement and the dimensions of a real test rotary member to which each respective calibration mass is fixed, in each calibration run. The correction factors for different axial positions or spacings of the calibration planes from the measurement planes in which measurement sensors for detecting the forces involved are arranged do not exactly linearly change, so that extrapolation of a respective correction factor to the respective measurement plane in which the respective measurement center is disposed involves error, due to the inherent nature of the system involved.

### SUMMARY OF THE INVENTION

An object of the invention is to provide a method of calibrating an unbalance measuring apparatus, which can provide for an improved calibration effect.

A further object of the invention is to provide a method of calibrating an unbalance measuring apparatus, which can afford an improved calibration result with a simple operating procedure while enjoying versatility of implementation.

Still another object of the invention is to provide a method of calibrating an unbalance measuring apparatus, which is capable of affording an improvement in terms of allowing for systematic errors in the measuring apparatus.

Yet a further object of the invention is to provide an arrangement for calibrating an unbalance measuring apparatus, which while being of a simple structure can nonetheless afford enhanced accuracy of operation.

In accordance with the principles of the present invention in the method aspect the foregoing and other objects are attained by a method of calibrating an unbalance measuring apparatus, in which given calibration masses are caused to rotate about a measuring axis in given axial and radial positions in calibration runs. The forces which result from the unbalances caused by the calibration masses are measured. The measured forces are then evaluated for calibration of the unbalance measuring apparatus. In a calibration run, two calibration masses of the same or different size are caused to rotate simultaneously about the measuring axis in two axial planes.

Further in accordance with the principles of the invention in the arrangement aspect the foregoing and other objects are attained by an arrangement for calibrating an unbalance measuring apparatus comprising a measuring shaft which is rotatable about a measuring axis and on which a balanced test rotary member can be clamped. Calibration masses can be fixed to the test rotary member. Measuring sensors measure forces operative at the measuring shaft when the test rotary member rotates. An evaluation device is connected to the measuring sensors and evaluates the measured forces for calibration of the unbalance measuring apparatus. The test rotary member has fixing locations to which two calibration masses are fixed in different axial calibration planes, in a calibration run.

As will be seen in greater detail from the description of a preferred embodiment of the present invention, first and second calibration masses of the same or different sizes are simultaneously caused to rotate about the measuring axis, in a calibration run, in first and second different calibration planes which are at an axial spacing from each other. In that procedure, a calibration mass which rotates about the measuring axis is simulated in another calibration plane. The two real calibration masses can be fixed in the form of calibration weight members to a test rotary member in two different axial planes constituting calibration planes. The test rotary member is balanced and secured in appropriate fashion to a measuring shaft of the balancing machine in question.

In a preferred feature of the invention the calibrated masses or weights are arranged displaced through 180° relative to each other about the measuring axis and are caused to rotate in those positions about the measuring axis during the calibration run. That operation involves measuring the forces resulting from the unbalance which is produced by the calibration mass simulated by the two calibration masses. The measuring sensors which perform the force-measuring operations can be arranged in the usual manner at axial spacings at measurement locations of the measuring shaft, in an arrangement as is to be found for example in EP 0 133 299 B1, the disclosure thereof in this respect being incorporated into the present specification by virtue of reference thereto. It is however also possible for the measuring sensors to be arranged substantially in a single measuring plane perpendicular to the measuring shaft, and to form virtual measurement locations, in an arrangement as is to be found for example in DE 198 44 975 A1, the disclosure thereof in this respect being incorporated into the present specification by virtue of reference thereto.

The two calibration masses can be caused to rotate during the calibration run about the measuring axis at identical or different radii. As already indicated above, that affords a simulated calibration unbalance which can be determined by calculation from the positions and the sizes of the two simultaneously rotating calibration masses and which is preferably related by comparison to the forces measured by the measuring sensors. Then, using known linear equations, in respect of the moments involved, that then affords the correction values required for calibration purposes.

In accordance with a further preferred feature of the method of the invention a minor residual unbalance which is possibly present on the balanced test rotary member can be measured, prior to or after the calibration measuring operation, and compensated in the procedure for calibration of the measuring apparatus.

By virtue of suitably choosing the size of the two real calibration masses or weights and/or the position thereof, it is possible to simulate a calibration mass or calibration unbalance for the respective calibration run in a respective virtual calibration plane which results in optimum establishment of the systematic error of the measuring apparatus and thus optimised calibration. It will be appreciated that in particular the invention can be used to advantage in relation to unbalance measuring apparatuses in which the region of the real balancing planes is outside the real or virtual measuring planes, this involving therefore an overhung mounting configuration for the rotary member.

Further objects, features and advantages of the invention will be apparent from the description hereinafter of a preferred embodiment.

### BRIEF DESCRIPTION OF THE DRAWING

FIG. 1 diagrammatically shows the arrangement of first and second calibration masses in a first calibration run, and

FIG. 2 shows the arrangement of first and second calibration masses in a second calibration run.

### DESCRIPTION OF THE PREFERRED EMBODIMENT

Referring to the drawings, the two Figures thereof diagrammatically show essential components of an unbalance measuring apparatus, for example of a wheel balancing machine. They include a suitably rotatably supported measuring shaft 3 having suitable clamping mounting means for fixing on the measuring shaft 3 a rotary member which is to be measured for balancing purposes, for the purposes of carrying out an unbalance measuring operation. The measuring shaft 3 is rotatable about a measuring axis indicated by reference numeral 2 and is driven in rotation in appropriate manner by a drive (not shown). The measuring shaft 3 is supported at first and second measuring sensors 10 and 11 which are arranged at an axial spacing from each other, in relation to the measuring axis 2. Forces emanating from the measuring shaft 3 during rotation thereof are detected by the measuring sensors 10 and 11 and converted into corresponding electrical signals which can then be passed for evaluation to an evaluation assembly (not shown).

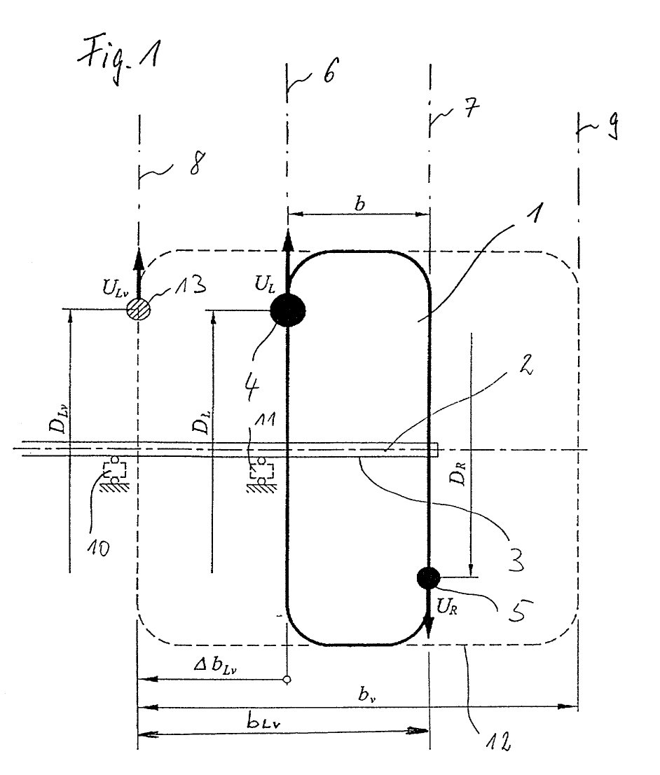

A real test rotary member 1 which is in an at least substantially balanced condition is provided for the respective calibration runs. The test rotary member 1 is fixed and centered on the measuring shaft 3 by known clamping means of suitable structure, for calibration of the unbalance measuring apparatus. For simulation of a given calibration unbalance, a first and a second calibration mass 4, 5 in the form of actual weight members are fitted in real calibration planes 6, 7 of the test rotary member 1. For the calibration run shown in FIG. 1, the first calibration mass 4 of a size U_{L} [g] is disposed in the first real calibration plane 6. The second calibration mass 5 of a size U_{R} [9] is disposed in the second real calibration plane 7. The two calibration masses are arranged on the test rotary member 1 displaced relative to each other through 180°, with respect to the measuring axis 2.

A simulated calibration mass 13, constituting a virtual calibration weight member, of a size U_{Lv} [g], is formed by the two calibration masses 4, 5, in a first simulated calibration plane 8 which can be referred to as a virtual calibration plane. In the calibration run shown in FIG. 1, the first calibration mass 4 rotates about the measuring axis 2 on a circle of a diameter D_{L} [mm]. The second calibration mass 5 rotates about the measuring axis 2 on a circle of a diameter D_{R} [mm]. The two calibration planes 6, 7 are at an axial spacing from each other as indicated at b [mm]. That affords the diameter for the circle of rotary movement of the simulated calibration mass as indicated at 13, as identified by D_{Lv} [mm]. As can be seen from FIG. 1 the left-hand calibration plane is displaced by the amount Δb_{Lv} [mm] in the axial direction towards the left with respect to the simulated calibration plane 8, when the illustrated relationships of the parameters involved apply.

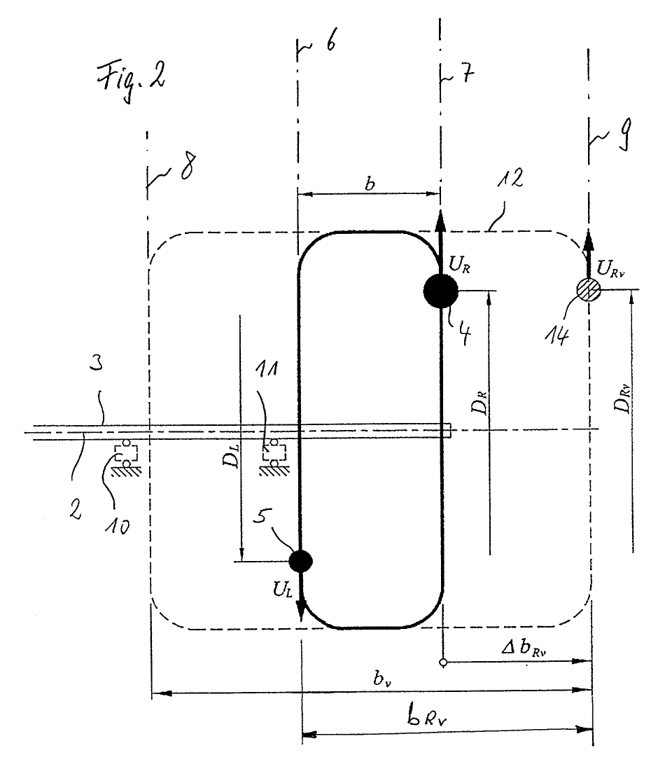

In the case of the arrangement of the two calibration masses 4, 5 as shown in FIG. 2, there is a second simulated calibration mass 14 in a second simulated calibration plane 9. For that purpose the calibration mass 4 of the size U_{R} [9] is arranged in the right-hand real calibration plane 7 and the second calibration mass 5 of the size U_{L} [g] is arranged in the left-hand real calibration plane 6 of the real test rotary member 1. The calibration mass 4 rotates on a circle of the diameter D_{R} [mm] and the calibration mass 5 rotates on a circle of the diameter D_{L} [mm] about the measuring axis 2 during the calibration run. The second simulated calibration mass 14 is of a size U_{Rv} [g]. It rotates on a circle of a diameter D_{Rv} [mm] about the measuring axis 2. The second simulated calibration plane 9 is displaced towards the right by an axial distance Δb_{Rv} [mm], with respect to the real right-hand calibration plane 7, when the relationships in respect of the parameters involved apply.

When carrying out the two calibration runs shown in FIGS. 1 and 2, a simulated test rotary member 12 which is shown by broken lines in FIGS. 1 and 2 is formed. The simulated test rotary member 12 has the left-hand simulated calibration plane 8 and the right-hand simulated calibration plane 9, in which are respectively simulated the two virtual calibration masses 13 and 14 which are respectively formed by the two real calibration masses 4 and 5.

The relevant sizes and positions of the simulated calibration masses 13 and 14 on the simulated test rotary member 12 are afforded on the basis of the following relationships. The size of the simulated calibration masses 13 and 14 arise out of the condition that the sum of all transverse forces becomes zero. For the two calibration runs in FIGS. 1 and 2, that affords the following relationships:

U_{L}D_{L}+(−U_{R})·D_{R}−U_{Lv}·D_{Lv}=0

and therefrom:

$${U}_{Lv} = \frac{{U}_{L} \cdot {D}_{L} - {U}_{R} \cdot {D}_{R}}{{D}_{Lv}}$$

for the calibration run of FIG. 1;

and

$${U}_{Rv} = \frac{{U}_{L} \cdot {D}_{L} - {U}_{R} \cdot {D}_{R}}{{D}_{Rv}}$$

for the calibration run of FIG. 2.

The axial positions of the simulated calibration masses 13 and 14 arise out of the condition that the sum of the moments becomes zero

Having regard to the different diameters of the paths of rotary movement of the two calibration masses, the following relationship applies in regard to the calibration run in FIG. 1:

U_{L}·D_{L}·b−U_{Lv}·D_{Lv}·b_{Lv}=0

and therefrom

$${b}_{Lv} = \frac{{U}_{L} \cdot {D}_{L} \cdot b}{{U}_{Lv} \cdot {D}_{Lv}}$$

and for the calibration run in FIG. 2:

−U_{R}·D_{R}·b+U_{Rv}·D_{Rv}·b_{Rv}=0

and therefrom

$${b}_{Rv} = \frac{{U}_{R} \cdot {D}_{R} \cdot b}{{U}_{Rv} \cdot {D}_{Rv}}$$

The axial displacements of the left-hand simulated calibration plane 8 relative to the real left-hand calibration plane 6 are calculated as follows:

$$Δ {b}_{Lv} = \frac{- {U}_{R} \cdot {D}_{R} \cdot b}{{U}_{Lv} \cdot {D}_{Lv}} = b - {b}_{Lv}$$

Similarly thereto the axial displacement of the right-hand simulated plane 9 relative to the real right-hand calibration plane 7 is as follows:

$$Δ {b}_{Rv} = \frac{{U}_{L} \cdot {D}_{L} \cdot b}{{U}_{Rv} \cdot {D}_{Rv}} = {b}_{Rv} - b$$

With the two calibration runs of FIGS. 1 and 2, that gives a total width of that simulated test rotary member 12 as follows:

bᵥ=b_{Lv}+b_{Rv}−b=b−Δb_{Lv}+Δb_{Rv}

By virtue of suitable choice of the sizes and positions of the real calibration masses, it is possible to form simulated calibration masses which, in each respective calibration run, produce a calculatable calibration unbalance with which the current measuring apparatus can be better analysed and error parameters can be ascertained at the most advantageous positions. In that way it is possible to detect systematic defective performance which may possibly occur at the measuring apparatus, and compensate for same with a high degree of accuracy, by means of the calibration procedure. In particular the two calibration masses or calibration unbalances can be arranged in the two calibration planes at identical angular positions. That provides for simulating calibration unbalances which are in calibration planes between the two real calibration planes 6, 7. If the two calibration masses are of the same size, it is possible to simulate a statistical calibration unbalance.

It is further possible for a simulated calibration unbalance to be combined with a calibration mass which is disposed in one of the two real calibration planes 6 and 7. For that purpose then an additional calibration run is carried out, with only one calibration mass, in one of the two real calibration planes.

It will be appreciated that the above-described embodiment of the method and arrangement according to the invention for calibration of an unbalance measuring apparatus have been set forth solely by way of example and illustration of the principles of the invention and that various modifications and alterations may be made therein without thereby departing from the spirit and scope of the invention.

What is claimed is:

1. A method of calibrating an unbalance measuring apparatus including
causing given calibration masses to rotate about a measuring axis in given axial and radial positions in calibration runs,
measuring the forces which result from unbalances caused by the calibration masses, and
evaluating the measured forces for calibration of the unbalance measuring apparatus,
wherein in a calibration run first and second calibration masses are caused to rotate simultaneously in first and second axial planes about the measuring axis.

2. A method as set forth in claim 1
wherein the calibration masses are of the same size.

3. A method as set forth in claim 1
wherein the calibration masses are of different sizes.

4. A method as set forth in claim 1
wherein the calibration masses are caused to rotate about the measuring axis at angular positions which are displaced through 180° relative to each other.

5. A method as set forth in claim 1
wherein the calibration masses are caused to rotate about the measuring axis in identical angular positions.

6. A method as set forth in claim 1
wherein the calibration masses are caused to rotate about the measuring axis at identical radii.

7. A method as set forth in claim 1
wherein the calibration masses are caused to rotate about the measuring axis at different radii.

8. A method as set forth in claim 1
wherein in addition at least one calibration run is effected with only one calibration mass in one of the first and second real calibration planes.

9. A method as set forth in claim 1
wherein the first and second calibration masses are fixed to a balanced test rotary member.

10. A method as set forth in claim 9
wherein prior to at least one calibration run residual unbalance of the test rotary member is measured and compensated in calibration of the measuring apparatus.

11. A method as set forth in claim 9
wherein after at least one calibration run residual unbalance of the test rotary member is measured and compensated in calibration of the measuring apparatus.

12. An arrangement for calibrating an unbalance measuring apparatus comprising
a measuring shaft,
means supporting the measuring shaft rotatably about a measuring axis,
mounting means for mounting a balanced test rotary member on the measuring shaft,
fixing means for fixing calibration masses to the test rotary member at fixing locations to which in a calibration run first and second calibration masses are fixed in different axial calibration planes,
measuring sensors adapted to measure forces operative at the measuring shaft when the test rotary member rotates, and
an evaluation means connected to the measuring sensors and adapted to evaluate the measured forces for calibration of the unbalance measuring apparatus.

13. An arrangement as set forth in claim 12
wherein the first and second calibration masses are arranged displaced relative to each other through an angle of 180° about the measuring axis.

14. An arrangement for calibrating an unbalance measuring apparatus comprising a measuring shaft, means supporting the measuring shaft rotatably about a measuring axis, and means for driving the measuring shaft in rotation,
the arrangement including
mounting means for mounting a balanced test rotary member on the measuring shaft,
fixing means for fixing calibration masses to the test rotary member at fixing locations to which in a calibration run first and second calibration masses are fixed in different axial calibration planes,
measuring sensors adapted to measure forces operative at the measuring shaft when the test rotary member rotates, and
an evaluation means connected to the measuring sensors and adapted to evaluate the measured forces for calibration of the unbalance measuring apparatus.
